(19) United States
(12) Patent Application Publication
(10) Pub. No.: US 2012/0264220 A1
(43) Pub. Date: Oct. 18, 2012

(54) Apparatus for Monitoring Corrosion and Method Thereof

(76) Inventors: M. Aflal Rahmathullah, Louisville, KY (US); Michael W. Osborne, Louisville, KY (US); Cheah Wei Ng, Selangor (MY)

(21) Appl. No.: 13/087,059

(22) Filed: Apr. 14, 2011

(51) Int. Cl. G01N 31/00

(52) U.S. Cl. 436/6

(57) ABSTRACT

An apparatus and method for monitoring and determining corrosion rates in an airflow wherein the corrosion rate is dynamically corrected for non-corrosive environmental effects.

### CROSS-REFERENCE TO RELATED DOCUMENTS

None.

### TECHNICAL FIELD

The invention relates generally to an apparatus for monitoring corrosion and a method thereof. More specifically, the invention relates to an apparatus and method for monitoring corrosion either cumulatively or incrementally and reporting a corrosion value that is dynamically corrected for external and environmental factors.

### BACKGROUND

It is desirable to detect corrosive contaminants in ventilation systems, so as to ascertain when filtration devices need to be changed or to correct the corrosive contaminant and remove such from the airflow. The corrosive contaminants may cause metal oxides, sulfides or other complexes to form due to a resultant reaction with oxygen in the air or by mixture with other compounds in an industrial process, for example.

One means of measuring corrosion and corrosive contaminants is termed the coupon method, which uses sacrificial metal coated coupons, such as those referenced in the SAAF® brochure. Corrosion coupons have been utilized to measure corrosion within an airflow caused by preselected contaminants and predominantly use either Silver or Copper based reactive metals. The coupons may be selected based on the type of contaminant which is desired to be detected as a cause of corrosion. A coupon is placed in contact with the airflow being measured and the corrosion of the coupon is measured at a later date. However, various problems with the use of coupons are known. For example, one problem requires the use of a new coupon each time a new reading is needed so as to provide a baseline measurement for corrosion amount on the coupon. Thus, a new coupon must be utilized each time to provide an accurate measurement of the corrosive contaminants. In addition, there is considerable effort and expense involved in the deployment and the analysis of these coupons. At the same time, the readings are not instantaneous due to the analysis of the coupons required at a laboratory. It is thus desirable to provide a more instantaneous, robust and accurate method of measuring corrosion which also takes into account environmental conditions.

Due to such problems, additional structures and devices have been developed for measurement of corrosion and correlation to corrosion standards (ISA 71.01-85). Examples of these are the Copper and Silver coated quartz crystal microbalances (QCMs) referenced by Osborne et al. (U.S. Pat. No. 5,208,162) the entirety of which is incorporated by reference.

There are several reviews of the method of operation of quartz crystal microbalances as mentioned by for example Tsionsky, V. J., The Quartz-Crystal Microbalance in an Undergraduate Laboratory Experiment. I. Fundamentals and Instrumentation, Journal of Chemical Education, 84 (8), 1334-1336, August 2007. The following is a brief introduction of the technique and its relation to corrosion monitoring as used herein. The physical basis of operation of a QCM lies in the piezoelectric effect, where the application of a mechanical stress across the surface of acentric materials (such as quartz) results in an electric potential across the surface. The most commonly-used orientation of a quartz crystal are AT-cut due to its insensitivity to frequency drift with temperature. The relationship between the frequency change (Δf) and mass change per unit area (Δm) on a QCM are related by the following equations attributed to Sauerbrey and discussed by Ward and Buttry, In situ Interfacial Mass Detection with Piezoelectric Transducers, Science Vol. 249: 1000-1007, Aug. 31, 1990:

$$\begin{matrix}Δ {f}_{m} = - {C}_{m} Δ m & ( 1 ) \\ {C}_{m} = {C}_{m}^{0} {f}_{0}^{2} & ( 2 ) \\ {C}_{m}^{0} = 2.257 \times {10}^{- 6} \frac{Hz}{ng \text{/} {cm}^{2}} & ( 3 )\end{matrix}$$

Where the constant Cₘ is determined by the properties of quartz alone (such as the density and shear modulus), f₀ represents the fundamental (or resonant) frequency of the crystal and Cₘ⁰ is a constant for the crystal. It should be noted that this equation is relevant for determination of mass changes only under conditions where the film is rigid, and under evenly distributed mass changes.

It is easily seen from these equations that for a crystal with a known resonant frequency, the frequency change would be directly proportional to the mass change on the active electrode area. For crystals that are coated with corrodible elements such as copper or silver, the oxides or sulfides of copper and silver would constitute a mass change on the surface of the electrode. This mass change would be proportional to the shift in frequency. This frequency shift is then correlated to industry-accepted standards based on the coupon method so that corrosion readings generated using a QCM can be presented in a manner similar to historically accepted terminology, such as that described in ISA-71.04.

In generic terms, such crystals are connected to a counter and a frequency reading is provided. Problems with these QCMs are that scattered readings may be provided by the QCM due to environmental noise resulting in unstable and inaccurate contaminant readings. Known QCM devices cannot discern between corrosion related and non-corrosion or environmentally related effects.

It would be highly desirable to overcome these deficiencies in current methods and structures for monitoring and measuring corrosion for a cumulative period or a desired incremental period of time. It would be highly desirable to measure such corrosion while also dynamically correcting for factors which may mistakenly alter the frequency shift of a coated crystal.

### SUMMARY

It would be useful to provide a quartz crystal microbalance utilizing a coated crystal to monitor and report corrosion in a manner widely recognized as an industry standard reactivity monitoring procedure.

It would be useful to provide a quartz crystal microbalance having one or more inert QCMs to isolate environmental disturbances of frequency changes.

It would be useful to provide a corrected corrosion rate wherein the corrected value compensates for environmental affects not necessarily related to the contaminants causing corrosion.

An apparatus for monitoring corrosion in a corrosive atmosphere comprises a first quartz crystal microbalance with known resonant frequency being coated with a corrodible metallic electrode which will react with corrosive contaminants, a second quartz crystal microbalance with known resonant frequency having a passive metallic coating which is non-reactive with the corrosive contaminants, a counter in electronic communication with the first and second quartz crystal microbalances, at least one oscillator in electronic communication with the first quartz crystal microbalance and the second quartz crystal microbalance, the counter measuring a first frequency value of the first quartz crystal microbalance at a first time and a second frequency value of the first quartz crystal microbalance at a second time, a processor in electronic communication with the at least one oscillator and the counter, the processor determining a first differential in the first and second frequency values of the first quartz crystal microbalance, the at least one counter measuring a first frequency value of the second quartz crystal microbalance at a first time and a second frequency value of the second quartz crystal microbalance at a second time, the processor determining a second differential in the first and second frequency values of the second quartz microbalance, the processor compensating for degradation of frequency value caused by external factors other than the corrosive contaminants by subtracting the second differential from the first differential, the processor providing an output signal, the output signal being related to an amount of corrosion corrected for external factors which cause a change in the first quartz crystal microbalance. The apparatus wherein the coating of the corrodible metallic electrode on the first quartz crystal microbalance is formed of at least one of silver and copper. The apparatus wherein the coating of non-corrodible metallic electrode on the second quartz crystal microbalance is gold. The apparatus wherein the external factors include environmental factors exclusive of the corrosive contaminants. The apparatus wherein the output signal is solely indicative of corrosive effects caused by the corrosive contaminants. The apparatus wherein the output signal eliminates corrosion rate caused by environmental factors.

An apparatus for monitoring corrosive contaminants comprises a first piezoelectric crystal being coated with a first corrodible coating, the corrodible coating being reactive with at least one specific contaminant in an airflow containing corrosive contaminants, a second piezoelectric crystal being coated with a second coating, the second coating being inert with the specific contaminants in the airflow containing corrosive contaminants, a holder retaining the first and second piezoelectric crystals and having leads for electronic connection with the first and second crystals, at least one oscillator in electric communication with the first and second piezoelectric crystals, at least one counter in first communication with the first crystal and in second communication with the second crystal for determining oscillation frequency of the first and second crystals, a processor receiving the oscillation frequencies of the first and second crystals and determining a differential between oscillation frequencies of the first and second crystals, an output provided by the processor, the output representing one of an amount of or rate of corrosion caused by the at least one specific contaminant in the airflow.

An apparatus for monitoring corrosion comprises a first quartz crystal microbalance disposed in an airflow with a corrosive contaminant, the first quartz crystal coated with a first metal reactive with the contaminant, a second quartz crystal microbalance disposed in an airflow with a corrosive contaminant, the second quartz crystal coated with a second metal reactive with the contaminant, a third quartz crystal microbalance disposed in an airflow with a corrosive contaminant, the third quartz crystal coated with a third metal non-reactive with the contaminant, wherein the quartz crystal microbalances are oscillated at a first frequency at a first time and a second frequency at a second time, a frequency differential is determined between the first time and the second time for each of the microbalances, the differential for the third quartz crystal microbalance is subtracted from each of the differentials for the first and second quartz crystal microbalances, a corrosion rate is determined corrected for environmental conditions.

A method for monitoring corrosion in a corrosive atmosphere comprises exciting a first quartz crystal microbalance in the corrosive atmosphere, the first quartz crystal microbalance having a corrodible metallic coating which will react with corrosive contaminants, exciting a second quartz crystal microbalance in the corrosive atmosphere, the second quartz crystal microbalance having a passive metallic coating which is non-reactive with the corrosive contaminants, measuring a first frequency differential of the first quartz crystal microbalance over a first time period, measuring a second frequency differential of the second quartz crystal microbalance over a second time period wherein the second time period may or may not be contemporaneous with the first time period, subtracting the second frequency differential from the first frequency differential to calculate a corrected change in frequency, calculating a value representing a corrosion thickness, a corrosion rate, or a corrosion class corresponding to the corrected change in frequency of the first crystal based solely on the corrosion contaminants, outputting a value representing one of an amount of corrosion, a corrosion rate, or a corrosion class. The method wherein the first quartz crystal microbalance comprises at least one of silver or copper. The method wherein the second quartz crystal microbalance comprises gold. The method wherein the calculating includes inputting a time interval. The method wherein the calculating includes inputting a temperature and relative humidity. The method wherein if the corrosion thickness is greater than 4000 Angstroms, then an error output signal is provided.

A method of monitoring corrosion comprises measuring temperature and relative humidity and recording the temperature and relative humidity, taking a first frequency measurement of at least one coated quartz crystal microbalance, taking a second frequency measurement of the at least one coated quartz microbalance, taking a first frequency measurement of a reference material coated quartz crystal microbalance, taking a second frequency measurement of a reference material coated quartz crystal microbalance, determining a corrected differential between the first and second measurements of the coated and reference material coated quartz crystals, determining a corrosion rate using a predefined equation. The method further comprising determining whether a constant can be utilized to be determine a corrosion rate. The method wherein the corrosion rate is a cumulative corrosion rate. The method wherein the corrosion rate is an incremental corrosion rate. The method wherein the first measurements are frequency reading at an in-service time of the quartz crystal microbalances. The method wherein a corrosion class is output. The method further comprising determining a frequency of the QCMs at equilibrium.

A method of monitoring corrosion comprises measuring a first oscillation frequency differential between a first time and a second time for a first corrodible metal coated quartz crystal microbalance, measuring a second oscillation frequency differential between the first time and the second time for a second corrodible metal coated quartz crystal microbalance, measuring an oscillation frequency differential between the first time and the second time for a third reference metal coated quartz crystal microbalance, subtracting the frequency differentials of the reference metal coated quartz crystal microbalances from the frequency differential of each of the corrodible metal coated quartz crystal microbalances to determine a corrected frequency differential value for each of the corrodible metal coated quartz crystal microbalances, determining a cumulative and incremental corrosion rate using a predefined equation and using the corrected frequency differential values. The method of monitoring corrosion wherein the corrosion rate is cumulative. The method of monitoring corrosion wherein the corrosion rate is incremental. The method of monitoring corrosion wherein the corrosion rate is incremental. The method of monitoring corrosion wherein one of the first and second quartz crystal microbalances is silver and the other of the first and second quartz crystal microbalances is copper. The method of monitoring corrosion wherein the third reference coated quartz crystal microbalance is coated with gold.

### BRIEF DESCRIPTION OF THE ILLUSTRATIONS

The above-mentioned and other features and advantages of this invention, and the manner of attaining them, will become more apparent and the invention will be better understood by reference to the following description of embodiments of the invention taken in conjunction with the accompanying drawings, wherein:

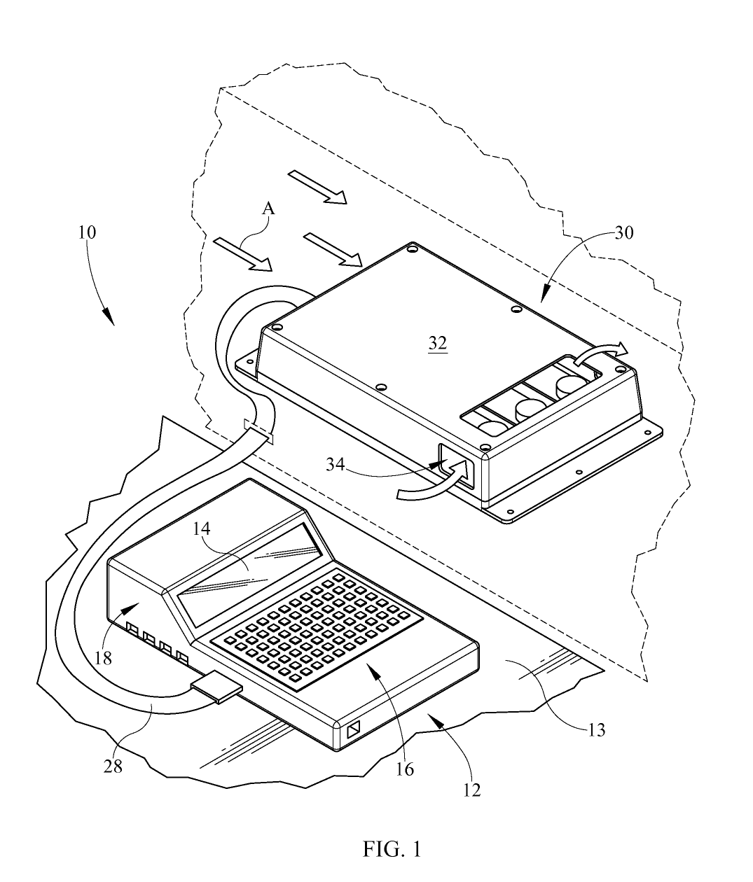

FIG. 1 depicts a perspective view of an exemplary apparatus or system for monitoring corrosion causing contaminants in an airflow;

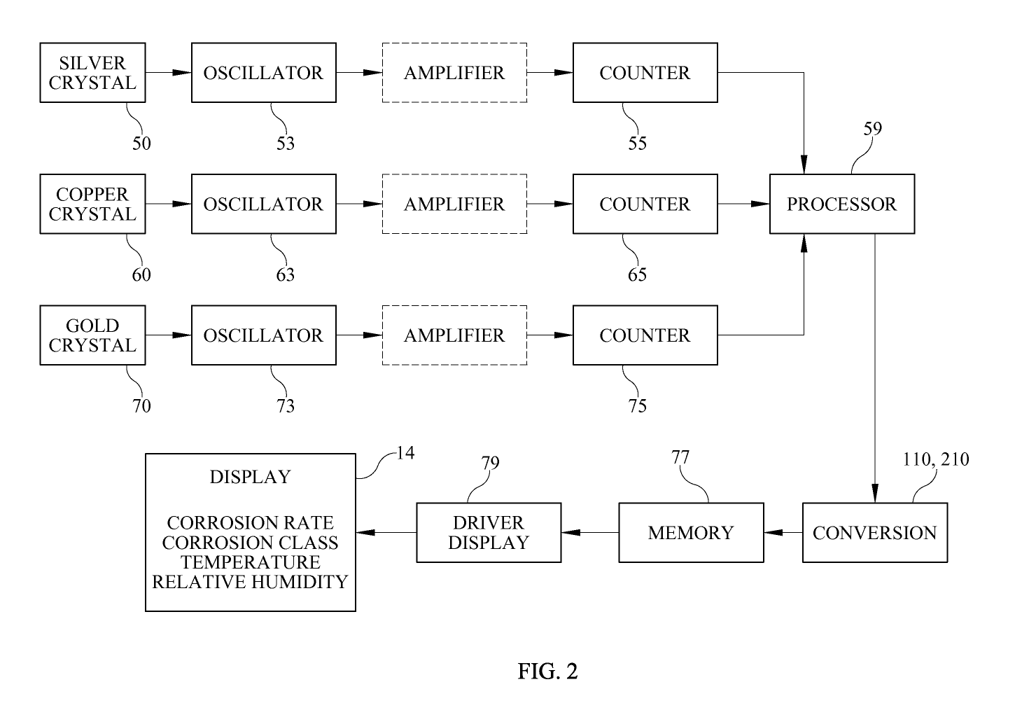

FIG. 2 depicts a schematic flow chart of the exemplary apparatus of FIG. 1;

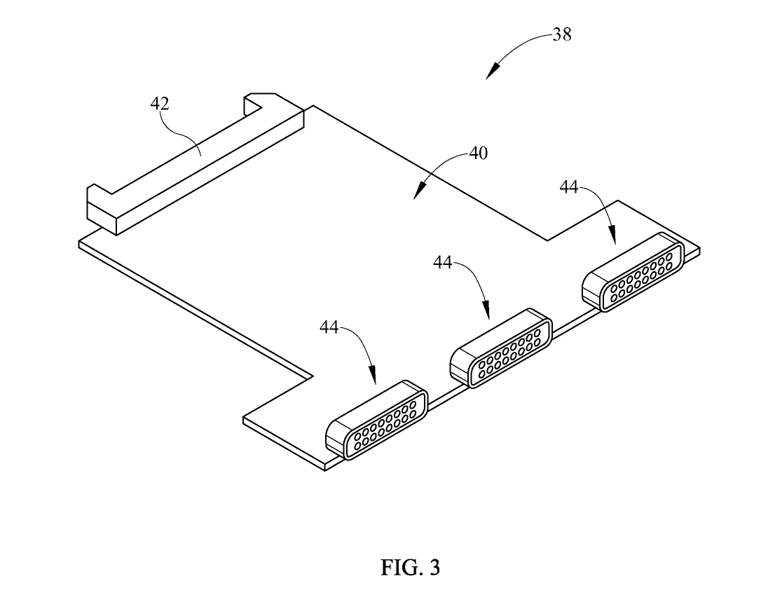

FIG. 3 depicts a perspective view of a connector plate disposed within a mounting unit;

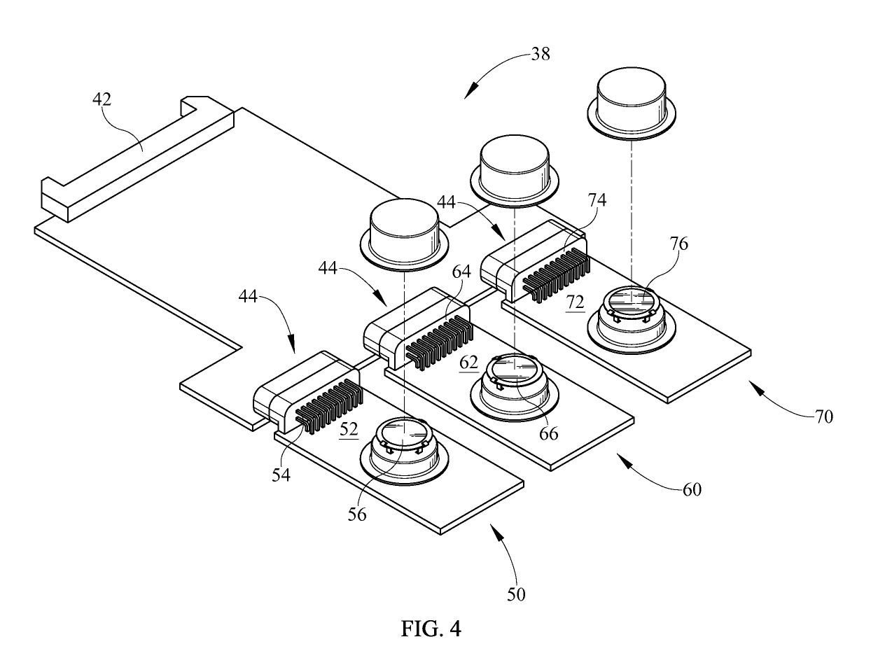

FIG. 4 depicts a perspective view of a connector plate and three quartz crystal microbalances electrically connected to the connector plate;

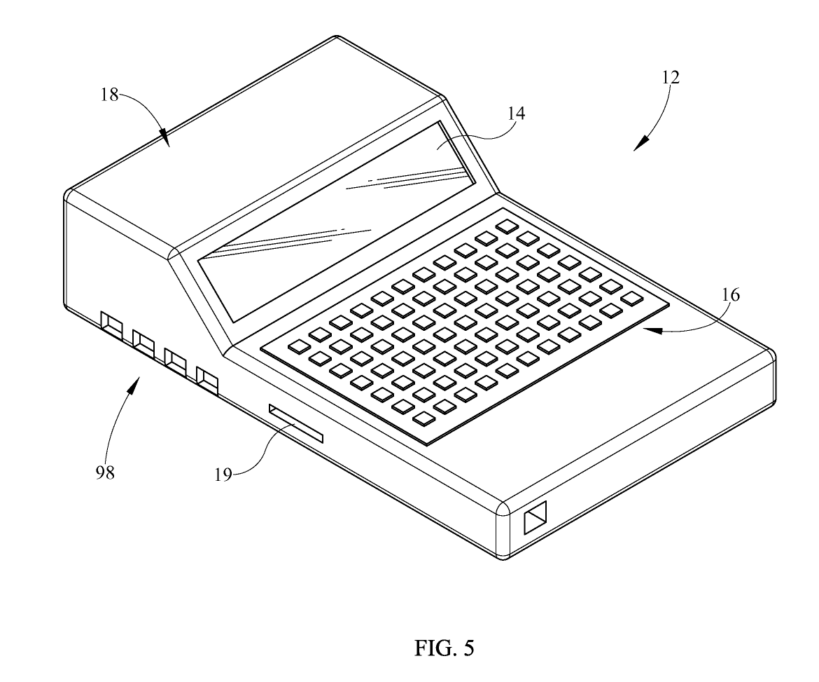

FIG. 5 depicts a perspective view of a reading unit which is connected to the mounting unit;

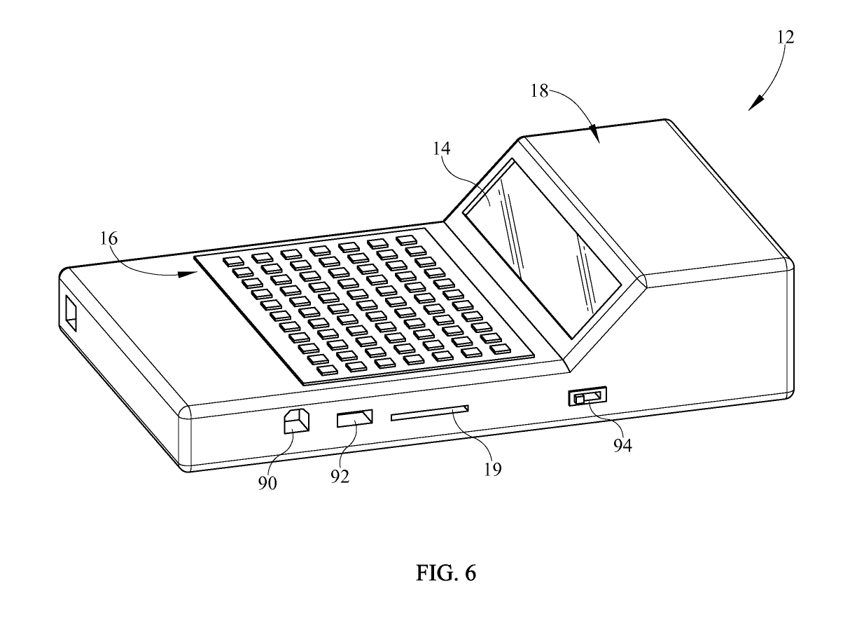

FIG. 6 depicts an alternative perspective view of the reading unit of FIG. 5;

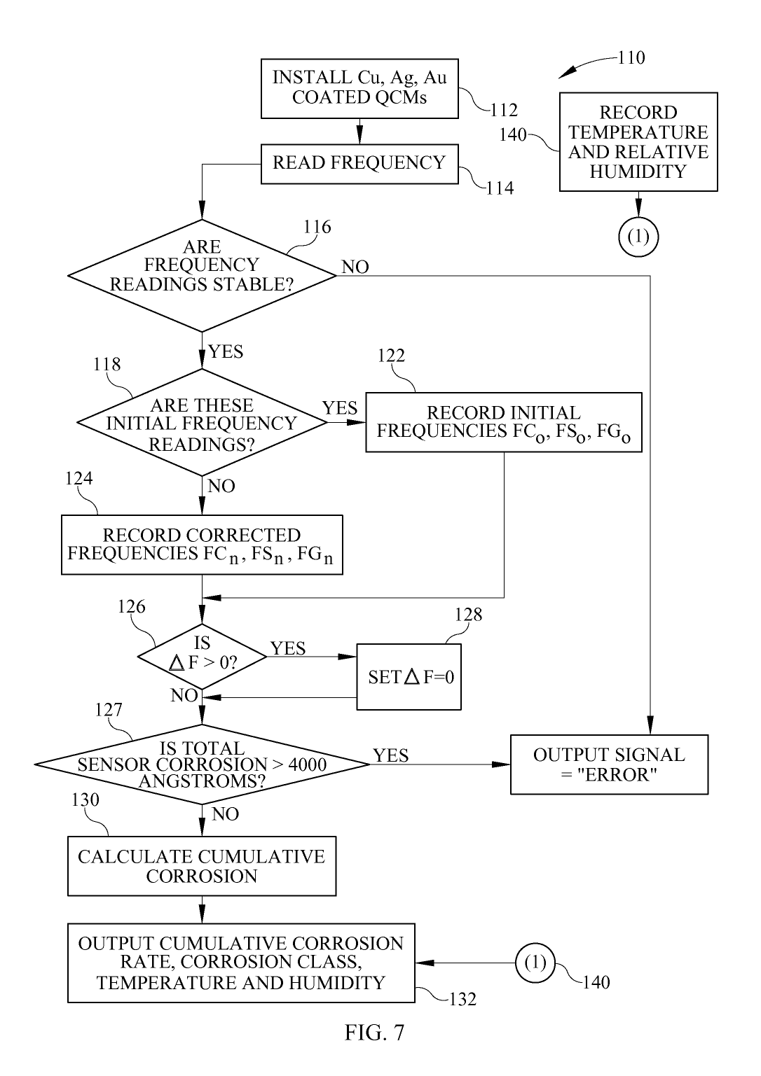

FIG. 7 depicts a first flowchart for determining an incremental corrosion rate; and,

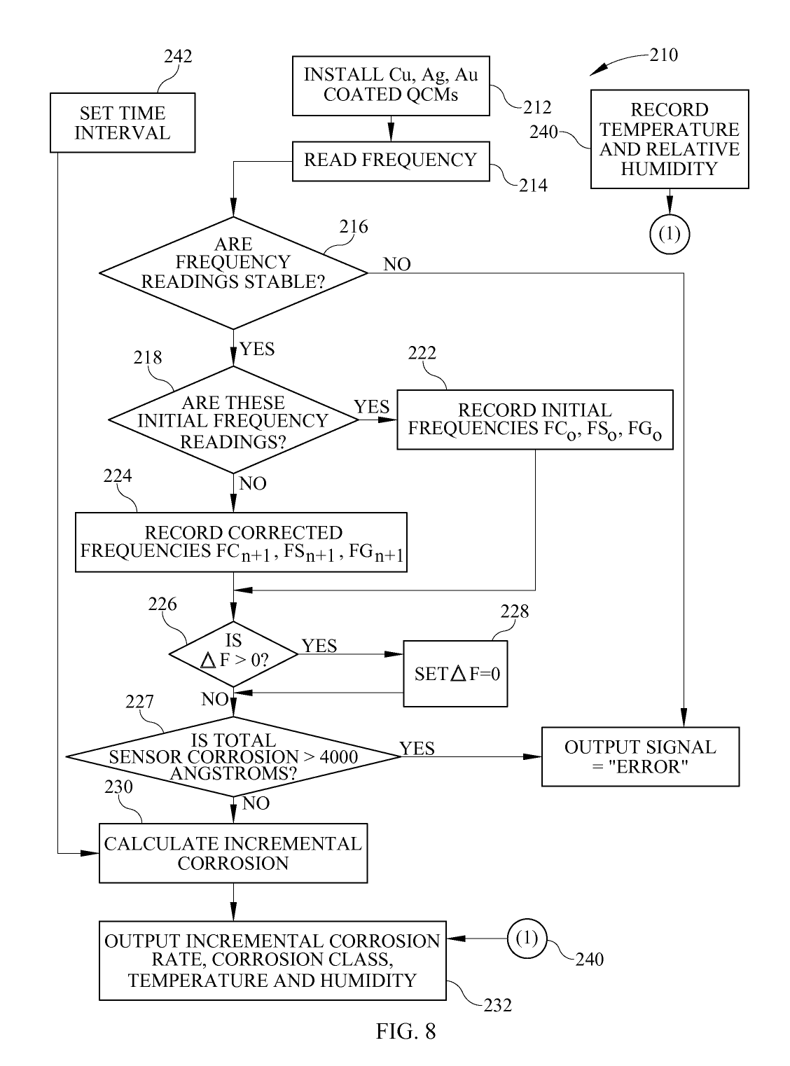

FIG. 8 depicts a first flowchart for determining a cumulative corrosion rate.

### DETAILED DESCRIPTION

It is to be understood that the invention is not limited in its application to the details of construction and the arrangement of components set forth in the following description or illustrated in the drawings. The invention is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings.

An apparatus for monitoring corrosion and method thereof is shown in the various FIGS. 1-8. The apparatus utilizes three or more quartz crystal microbalances to detect and calculate corrosion causing contaminants in an airflow and display such either cumulatively or incrementally to a user. Two of the QCM coatings are reactive to corrosive contaminants while the third is considered to be inert to corrosive reactions. This third QCM is coated with an inert material so that it does not react to the airborne contaminants and therefore is only affected by environmental causes, and not corrosive events. Accordingly, the frequency change of the two reactive QCMs may be corrected to numerically remove non-corrosion events, allowing the contaminant caused corrosion rate to be isolated and determined.

Referring initially to FIG. 1, a perspective view of an apparatus or system 10 for sensing corrosion is depicted. The sensing apparatus 10 includes a reading unit 12 disposed on the outside of an air handling equipment 13, such as a HVAC system. Alternatively, monitoring apparatus may be used in industrial processing measurement and control rooms, motor control centers, electrical rooms, semiconductor clean rooms, electronics manufacturing facilities, commercial data centers, museums, storage facilities and the like. The system 10 may also be useful to check exhaust levels of filtration media in order to estimate media change-out cycles.

In some embodiments, the reading unit 12 has a display 14 which will advise a user of various environmental conditions such as temperature, relative humidity, the calculated incremental corrosion rate or cumulative corrosion rate, and corrosion class. This list of displayable characteristics is not exhaustive, as various other characteristics may be displayed by the reading unit 12. The reading unit 12 may further comprise a plurality of input buttons 16. These buttons allow input and selections to be made. Extending from the housing 18 is a ribbon cable 28. The ribbon cable 28 extends to a mounting or detecting unit 30 within the HVAC system and exposed to an air stream A. The reading unit 12 may also include a processor 59 for calculating the corrosion rates and classes.

The detecting unit 30 includes a structure for allowing airflow to react with quartz crystal microbalances (QCMs) and measure change in frequencies of the microbalances over a select period of time in order to determine a rate of corrosion propagation caused by contaminants which react to specific coatings on the quartz crystal microbalances. Specifically, the oscillating frequency of the QCMs decreases as the metallic coating corrodes with time. The frequency reading is converted as described further herein to a corrosion rate and/or classification reading corresponding to known standards. By determining the corrosion rate of the coatings, a determination may be made as to corrosivity of the airstream. The mounting unit 30 includes a housing 32 with at least one aperture to allow airflow to reach the quartz crystal microbalances. The mounting unit 30 is depicted inside a broken line indicating positioning within an enclosure where an airflow A passes. Alternative structures may be formed wherein the reading unit 12 and the detecting unit 30 are formed in a single unit or alternatively the detecting unit may be in communication with computers and displays in a control room for monitoring.

Referring now to FIG. 2, a flow chart depicts schematic view of the apparatus 10 for monitoring corrosion. The system inputs measurements and calculates output readings for corrosion rates to the graphic display 14 on the reading unit 12. The sensor system provides quartz crystal microbalances 50, 60, 70. These are listed as silver, copper and gold, however the numerical designations 50, 60, 70 are not necessarily limited to the exemplary silver, copper and gold coatings, but instead may include alternate coatings. Each of the crystals is connected to an oscillator 53, 63, 73 which causes vibration of the coated crystals. An amplifier may be utilized to increase the frequency signal output by the crystals 50, 60, 70 and a counter 55, 65, 75 is utilized for each crystals in order to obtain a frequency reading. This structure is shown in broken line as such structure may not be necessary. These frequency readings are input to a processor 59 which performs conversion calculation 110, 210 described further herein. The conversions 110, 210 described further in FIGS. 7 and 8 may result in obtaining corrosion rate, corrosion class, temperature and relative humidity of the air stream. The calculations are stored in a memory 77 and sent to a driver display 79 for displaying on the display 14 or for storage for later retrieval.

Referring now to FIG. 3, a perspective view of a connector plate 38 is shown. The connector plate 38 is defined by a circuit board 40 having a ribbon cable connector 42 at one end of the printed circuit board 40 and a plurality of connectors 44 at the other end of the connector plate 38. In one embodiment, ribbon cable connector 42 receives a ribbon cable 28 so as to provide a communication link between the reading unit 12 and the detecting unit 30. The cable connector 42 may be for a ribbon cable but various alternative types of cable may be used for communication link and therefore one skilled in the art will realize that the cable should not be limited to the ribbon cable depicted. Alternatively, this communication link may be provided wirelessly or through various types of wired connections such as Bluetooth, 802.11 standards, or others. The connectors 44 allow connection of the quartz crystal microbalances described further herein so as to provide numerical inputs for calculations which may occur either in the printed circuit board 40 or in the reading unit 12 to be displayed on the display 14. As is known in the art, the circuit board 40 drives each of the crystals connected at connectors 44. The frequency of each crystal is measured and provides information related to corrosion rates.

Referring now to FIG. 4, the connector plate 38 is shown in perspective view with the QCMs 50, 60, 70 connected to the circuit board 40 at the connectors 44. Each of the QCM assemblies 50, 60, 70 includes a printed circuit board 52, 62, 72 a connector 54, 64, 74 and a coated quartz crystal 56, 66, 76 housed within the exploded caps. When connected, the QCM assemblies 50, 60, 70 are caused to vibrate at known frequencies which may be read and displayed at the reading unit 12. Over time, and due to contaminants and environmental conditions of the airstream, the frequency changes as corrosion builds on the QCMs 50, 60, 70.

According to the one embodiment, the three QCMs 50, 60, 70 each have a different coating so as to react to differing contaminants in an airstream. For example, one of the QCMs may be coated with a copper material, one of the QCMs may be coated with a silver material and one of the QCMs may be coated with a gold material. The copper and silver are known to react to various contaminants while also being affected by various external or environmental factors. While the gold material is not affected by such contaminants, it is affected by the various external or environmental factors such as particulate such as dust, temperature and relative humidity fluctuations and other factors and therefore is the reference material for the copper and silver exemplary coatings. While these exemplary coatings are described they are not to be considered limiting as other coatings may be utilized. For example, iron (FE), nickel (Ni), manganese (Mn), cobalt (Co), chromium (Cr), scandium (Sc), vanadium (V), titanium, (Ti), tin (Sn), magnesium (Mg), aluminum (Al), zinc (Zn), platinum (Pt) or other metallic coatings may be used to coat the crystals 50, 60, 70. Thus in various embodiments, one baseline QCM provides data related to frequency drift caused by non-corrosive environmental factors. This frequency drift may then be subtracted from each of the reactive QCM modules to determine an absolute frequency change caused only by corrosive environmental elements.

Referring now to FIGS. 5 and 6, perspective views of the reading unit 12 are shown. Along the one side of the unit, as shown in FIG. 6, multiple ports are provided including a ribbon cable port 19. For example, an Ethernet port 90, a USB port 92, and a power switch 94. A plurality of vents 98 are shown on an opposite side in FIG. 5.

Referring now to FIG. 7, a flowchart for determining a cumulative corrosion is depicted. The method 110 first involves installation of coated QCMs at step 112 into the system 10, for example copper, silver, and gold. Next, a frequency reading is made at step 114. Next, the system 10 makes a determination of whether the frequency reading is stable, i.e. at equilibrium. If the frequency reading is stable at decision 116, then the system 10 determines whether the reading step was an initial reading at step 118. If the determination at step 116 is that the frequency reading is not stable, the system 10.

At step 118, the system determines whether the frequency reading at step 114 is an initial reading. For initial readings, frequencies of the copper QCM, silver QCM, and gold QCM are recorded as FC₀, FS₀, and FG₀ as depicted at step 122. If these are not initial readings corrected frequencies FCₙ, FSₙ and FGₙ are recorded at step 124. In determining the cumulative corrosion, the initial frequency at time 0 is subtracted from the frequency at time n. The recordings of steps 122 and 124 are input into a decision 126 to determine if the change in frequency is greater than zero. If the answer is yes, the value of the ΔF is set to zero at step 128. If the answer is no, the system determines whether the corrosion thickness is equal to or greater than 4000 Angstroms at step 127. If the answer is yes, an error signal is output. If the answer is no, the cumulative or corrosion calculation is made at step 130. At step 132, the output for the cumulative corrosion rate, corrosion class, and relative temperature and humidity are output to the reading unit 12 at the display 14. In order to calculate the cumulative corrosion calculation at the step 130, the step requires the input of the temperature and relative humidity measurement performed at step 140 and a time interval measurement at step 142.

Referring now to FIG. 8, a method 210 is depicted for determining an incremental corrosion rate. The incremental corrosion rate differs from the cumulative in that the cumulative measures corrosion from initial in-service of the QCM to the time that the measurement is taken. The incremental corrosion rate is measured between a first instant at time “n” and a second instant at time “n+1” wherein one of the periods may not correspond to the initial in-service time of the QCMs.

As previously discussed, both methods, 110, 210 perform a calculation for cumulative and incremental corrosion rates, respectively. The system utilizes three coatings on the corresponding QCMs 50, 60, 70 in order to correct for environmental causes of corrosion, not necessarily related to the contaminants which a user desires to monitor. Once the environmental effects of corrosion are compensated for, the true rate of corrosion caused specifically by contaminants may be determined.

In calculating the cumulative corrosion or incremental corrosion rates, the frequencies of the QCMs must be corrected. For the silver QCM, a two-step operation occurs. First, if the frequency differential of the silver QCM is greater than zero (0), then the cumulative corrosion rate for silver is equal to the background corrosion value, background silver. This is expressed as:

IF FR_SILV_{—}C>0, THEN SILV_COR_{—}C=background_silver;

where SILV_COR_C=Cumulative Corrosion thickness in Angstroms/30 days.

Alternatively, the cumulative corrosion rate for silver is expressed as:

SILV_COR_{—}C=background_silver+((silver1*ABS(FR_SILV_{—}C)̂2+silver2*ABS(FR_SILV_{—}C)+background_silver)−background_silver)*30/(TIME/24).

where FR_SILV_C=frequency differential (delta frequency) between initial frequency reading (at time, t=0) and current frequency reading (at time, t=n), and corrected with gold frequency reading (FR_GOLD) at both these time instances, expressed as:

FR_SILV_{—}C=(FR_SILV|tₙ−FR_SILV|t₀)−(FR_GOLD|tₙ−FR_GOLD|t₀).

In the above equations, the constants background_silver, silver1 and silver2 are predefined constants as determined through calibration experiments that have been carried out. From historical experience we are aware that the total background corrosion on silver coupons (background_silver) should be in the range of 0-100 Angstroms/30 days and most preferably within a range 10-50 Angstroms/30 days. The values for silver1 and silver 2 are known to be constants between 0-0.2 and 0.2-1.0 respectively.

To determine the cumulative corrosion rate for the copper coated QCM there is also a two-step process. First, if the frequency differential of the copper QCM is greater than zero (0), then the cumulative corrosion rate for copper is equal to background_copper. This is expressed:

IF FR_COPP_{—}C>0, THEN COPP_COR=background_copper;

where COPP_COR_C=Cumulative Corrosion thickness in Angstroms/30 days.

Alternatively, the copper correction value is expressed as:

COPP_COR_{—}C=background_copper+((copper1*ABS(FR_COPP_{—}C)̂2+copper2*ABS(FR_COPP_C)+background_copper)−background_copper)*30/(TIME/24)

where FR_COPP_C=frequency differential (delta frequency) between initial frequency reading (at time, t=0) and current frequency reading (at time, t=n), and corrected with gold frequency reading (FR_GOLD), expressed as:

FR_COPP_{—}C=(FR_COPP|tₙ−FR_COPP|t₀)−(FR_GOLD|tₙ−FR_GOLD|t₀).

In the above equations, the constants background_copper, copper1 and copper2 are predefined constants as determined through calibration experiments that have been carried out. From historical experience we are aware that the total background corrosion on copper coupons (background_copper) should always be in the range of 0-120 Angstroms/30 days and most preferably within a range 50-120 Angstroms/30 days. The values for copper1 and copper2 are known to be constants between 0-0.2 and 0.2-1.0 respectively.

Once the corrected corrosion rates for copper and silver are determined, the corrosion classification may be performed. The exemplary Table 1 may be utilized to classify the corrosion rate as Mild, Moderate, Harsh or Severe based on the ISA standard 71.04-1985. These ratings are exemplary as fewer classifications or more classifications may be utilized.

TABLE 1

| Corrosion class (G | | |
|---|---|---|
| denotes copper, S | | |
| denotes silver) | COPP_COR (A/30 days) | SILV_COR (A/30 days) |
| G1, S1 (Mild) | <300 | <300 |
| G2, S2 (Moderate) | >300 and <1000 | >300 and <1000 |
| G3, S3 (Harsh) | >1000 and <2000 | >1000 and <2000 |
| GX, SX (Severe) | >= 2000 | >= 2000 |

Where a user prefers to determine incremental corrosion thickness rather than cumulative corrosion thickness, above formulae and correction factors still apply. However, the time differential is taken between two time instances, time n and time n+1 and is expressed as:

TIME=t₍ₙ₊₁₎−tₙ, in hours

so that for the silver coated QCM:

IF FR_SILV_{—}I>0, THEN SILV_COR_{—}I=background_silver

alternatively,

SILV_COR_{—}I=background_silver+((silver1*ABS(FR_SILV_{—}I)̂2+silver2*ABS(FR_SILV_{—}I)+background_silver)−background_silver)*30/(TIME/24).

where:

SILV_COR_I=Incremental Corrosion thickness in Angstroms/30 days

FR_SILV_I=Difference in frequency (delta frequency) between prior frequency reading (at time, t=n) and current frequency reading (at time, t=n+1), and corrected with gold frequency reading (FR_GOLD) at these two instants of time, expressed as:

FR_SILV_{—}I=(FR_SILV|tₙ₊₁−FR_SILV|tₙ)−(FR_GOLD|tₙ₊₁−FR_GOLD|tₙ)

For the copper coated QCM:

IF FR_COPP_{—}I>0, THEN COPP_COR_{—}I=background_copper

alternatively,

COPP_COR_{—}I=background_copper+((copper1*ABS(FR_COPP_{—}I)̂2+copper2*ABS(FR_COPP_{—}I)+background_copper)−background_copper)*30/(TIME/24)

where:

COPP_COR_I=Incremental Corrosion thickness in Angstroms/30 days

FR_COPP_C_I=Difference in frequency (delta frequency) between prior frequency reading (at time, t=n) and current frequency reading (at time, t=n+1), and corrected with gold frequency reading (FR_GOLD), expressed as:

FR_COPP_{—}I=(FR_COPP|tₙ₊₁−FR_COPP|tₙ)−(FR_GOLD|tₙ₊₁−FR_GOLD|tₙ).

The method of operation will now be described with reference to all of the Figures for selected embodiments. The system 10 is installed, including the reactive and non-reactive metallic QCMs, for example copper, silver and gold coated QCMs, at a location where an airflow or airstream A is housed and corrosion causing contaminants are desired to be monitored. The QCMs 50, 60, 70 in the mounting unit 30 are exposed to the air flow A. The system measures the QCM frequency and determines whether equilibrium has been met. Upon reaching equilibrium, a frequency measurement is taken for each of the QCMs 50, 60, 70. The first frequency may be an initial time “0” or may be a first reading at time “n”. After measuring a first oscillation frequency for all three QCMs, a second frequency reading is measured again for all three QCMs. The second frequency reading is taken at time “n” or time “n+1”. Once the frequencies are recorded, a frequency differential for the time period between readings may be calculated for each of the crystals. The frequency differential of each corrosive coated QCM is corrected by subtracting a frequency differential of the reference or non-reactive material coated QCM. This provides a corrected frequency differential.

If the differential is greater than zero, the cumulative or incremental corrosion rate is taken to be equal to the background corrosion rate. Alternatively, if the differential is not greater than zero, a calculation occurs wherein the frequency differential is utilized in a preset equation to calculate the cumulative or incremental corrosion rate. The difference between the cumulative time period and the incremental time period, as previously discussed, involves whether the differential in time period in frequency measurements includes an initial frequency measurement at the initial in-service time of the three QCMs. If the initial frequency measurement is included, the time period between that and the second time period is cumulative. Alternatively, an incremental time period includes a frequency measurement at a first time “n” and a second frequency measurement at a subsequent time “n+1”. Once the corrected corrosion rate is calculated, a corrosion class may further be determined utilizing the Table 1 previously described. If the corrosion rate is greater than four thousand angstroms per thirty day period, then an output error is signaled to the user of the system 10.

The foregoing description of several embodiments of the invention has been presented for purposes of illustration. It is not intended to be exhaustive or to limit the invention to the precise steps and/or forms disclosed, and obviously many modifications and variations are possible in light of the above teaching. It is intended that the scope of the invention and all equivalents be defined by the claims appended hereto.

What is claimed is:

1-8. (canceled)

9. A method for monitoring corrosion in a corrosive atmosphere, comprising:
exciting a first quartz crystal microbalance in said corrosive atmosphere, said first quartz crystal microbalance having a corrodible metallic coating which will react with corrosive contaminants;
exciting a second quartz crystal microbalance in said corrosive atmosphere, said second quartz crystal microbalance having a passive metallic coating which is non-reactive with said corrosive contaminants;
measuring a first frequency differential of said first quartz crystal microbalance over a first time period;
measuring a second frequency differential of said second quartz crystal microbalance over a second time period wherein said second time period may or may not be contemporaneous with said first time period;
subtracting said second frequency differential from said first frequency differential to calculate a corrected change in frequency;
calculating a value representing a corrosion thickness, a corrosion rate, or a corrosion class as defined by a standard corresponding to said corrected change in frequency of said first crystal based solely on said corrosion contaminants;
outputting a value representing one of an amount of corrosion, a corrosion rate, or a corrosion class as defined by a standard.

10. The method of claim 9 wherein said first quartz crystal microbalance comprises at least one of silver or copper.

11. The method of claim 9 wherein said second quartz crystal microbalance comprises gold.

12. The method of claim 9 wherein said calculating includes inputting a time interval.

13. The method of claim 9 wherein said calculating includes inputting a temperature and relative humidity.

14. The method of claim 9 wherein if said corrosion thickness is greater than 4000 Angstroms, then an error output signal is provided.

15. A method of monitoring corrosion, comprising:
measuring temperature and relative humidity and recording said temperature and relative humidity;
taking a first frequency measurement of at least one coated quartz crystal microbalance;
taking a second frequency measurement of said at least one coated quartz microbalance;
taking a first frequency measurement of a reference material coated quartz crystal microbalance;
taking a second frequency measurement of a reference material coated quartz crystal microbalance;
determining a corrected differential between said first and second measurements of the coated and reference material coated quartz crystals;
determining a corrosion rate using a predefined equation.

16. The method of claim 15 further comprising determining whether a constant can be utilized to be determine a corrosion rate.

17. The method of claim 15 wherein said corrosion rate is a cumulative corrosion rate.

18. The method of claim 15 wherein said corrosion rate is an incremental corrosion rate.

19. The method of claim 15 wherein said first measurements are frequency reading at an in-service time of said quartz crystal microbalances.

20. The method of claim 15 wherein a corrosion class is output.

21. The method of claim 15 determining a frequency of said QCMs at equilibrium.

22. A method of monitoring corrosion, comprising:
measuring a first oscillation frequency differential between a first time and a second time for a first corrodible metal coated quartz crystal microbalance;
measuring a second oscillation frequency differential between said first time and said second time for a second corrodible metal coated quartz crystal microbalance;
measuring an oscillation frequency differential between said first time and said second time for a third reference metal coated quartz crystal microbalance;
subtracting said frequency differentials of the reference metal coated quartz crystal microbalances from the frequency differential of each of the corrodible metal coated quartz crystal microbalances to determine a corrected frequency differential value for each of the corrodible metal coated quartz crystal microbalances;
determining a cumulative and incremental corrosion rate using a predefined equation and using said corrected frequency differential values.

23. The method of monitoring corrosion of claim 22 wherein said corrosion rate is cumulative.

24. The method of monitoring corrosion of claim 22 wherein said corrosion rate is incremental.

25. The method of monitoring corrosion of claim 22 wherein said corrosion rate is incremental.

26. The method of monitoring corrosion of claim 22 wherein one of said first and second quartz crystal microbalances is silver and the other of said first and second quartz crystal microbalances is copper.

27. The method of monitoring corrosion of claim 22 wherein said third reference coated quartz crystal microbalance is coated with gold.
